(19) United States
(12) Patent Application Publication
(10) Pub. No.: US 2020/0110776 A1
(43) Pub. Date: Apr. 9, 2020

(54) METAMODEL FOR GRAPH DATABASE

(71) Applicant: ATC IP LLC, Boston, MA (US)

(72) Inventor: Matthew Pollard, Swarthmore, PA (US)

(21) Appl. No.: 16/294,369

(22) Filed: Mar. 6, 2019

Related U.S. Application Data
(60) Provisional application No. 62/743,334, filed on Oct. 9, 2018.

(51) Int. Cl. G06F 16/901; G06F 16/21; G06F 16/732; G06F 16/28

(52) U.S. Cl. CPC G06F 16/9024; G06F 16/284; G06F 16/7335; G06F 16/211

(57) ABSTRACT

A technique for managing a graph database provides a metamodel as a schema for a data model. The metamodel resides in the graph database and includes a set of nodes, which define respective classes of nodes that may exist in the data model. Users may operate a user interface to create new nodes in the data model as instances of the node classes defined in the metamodel.

### CROSS-REFERENCES TO RELATED APPLICATIONS

This application claims the benefit of U.S. Provisional Patent Application No. 62/743,334, filed Oct. 9, 2018, the contents and teachings of which are incorporated by reference herein in their entirety.

### BACKGROUND

Graph databases are powerful tools that find countless applications in data science, information technology, and virtually any field in which it is desired to track diverse types of information. As compared with relational databases, which store data in tables, graph databases store data in the form of nodes. Each node may have a name as well as one or more labels, and multiple nodes may be grouped according to label. Relationships are formed between nodes, and each relationship has a start node and an end node. Each node of a graph database can have properties, and properties may be stored as key-value pairs.

Because graph databases represent data using nodes rather than tables, graph databases can run complex queries involving many diverse nodes using a relatively small amount of memory. Running similar queries using table-based databases might require numerous table joins, which can consume a great deal of memory and require long execution times. A popular graph database management system is Neo4j, which was developed by Neo4j, Inc. and which employs a query language called Cypher. Other examples of graph databases include JanusGraph, Giraph, and Dgraph, and other query languages include Gremlin and SPARQL.

### SUMMARY

Graph databases are typically schema-less, meaning that there is no enforcement of rules regarding the structures that nodes, properties, relationships, and labels can assume. This schema-less feature is an advantage to many users, who require flexibility in terms of data processing and analysis.

Unfortunately, the lack of schemas inherent in most graph databases can cause difficulties for non-experts. Indeed, the very lack of structure that experts enjoy is often a handicap to non-experts, who could benefit from the simplicity of more highly-structured data, particularly when performing manual data entry. Thus, there is a need for applying schemas to graph databases to facilitate their ease of use by non-experts and others.

To help address this need, an improved technique for managing a graph database provides a schema for a data model in the graph database by creating a metamodel. The metamodel resides alongside the data model and includes a set of nodes, which define respective classes of nodes that may exist in the data model. Users may operate a user interface to create new nodes in the data model as instances of the node classes defined in the metamodel.

In some examples, the new nodes inherit characteristics of the node classes, which limit the scope of permitted properties and/or relationships of the new nodes in the data model to those established for the respective node classes in the metamodel. In this manner, the node classes defined in the metamodel enforce structure on the instances of the node classes created in the data model, thereby enabling the metamodel to function as a schema for the data model.

Certain embodiments are directed to a method of managing a graph database. The method includes creating a metamodel in the graph database. The metamodel includes a first set of nodes, the first set of nodes defining respective node classes. The metamodel is created based at least in part on operation of a user interface served by a computing machine in communication with the graph database. The method further includes providing a data model in the graph database, the data model including a second set of nodes, the second set of nodes distinct from the first set of nodes. The method still further includes applying the metamodel as a schema for the data model, including instantiating, in response to operation of the user interface, new nodes of the data model as instances of respective node classes defined by the first set of nodes.

Other embodiments are directed to a computerized apparatus constructed and arranged to perform a method of managing a graph database, such as the method described above. Still other embodiments are directed to a computer program product. The computer program product stores instructions which, when executed by control circuitry of a computerized apparatus, cause the computerized apparatus to perform a method of managing a graph database, such as the method described above.

In some examples, both the metamodel and the data model operate within a single instance of the graph database.

According to some examples, creating the metamodel includes establishing a set of properties of a particular node of the first set of nodes. The set of properties define respective types of characteristics that the user interface permits users to assign to instances of the particular node created in the data model.

In some examples, establishing the set of properties of the particular node includes presenting, by the user interface, a control for specifying whether a property is required to be assigned by instances of the particular node created in the data model.

In some examples, creating the metamodel includes establishing a set of relationships for the particular node in the metamodel. The set of relationships define respective types of connections that are permitted by instances of the particular node with other nodes in the data model.

In some examples, establishing the set of relationships for the particular node in the metamodel includes establishing a particular relationship by (i) identifying another node in the metamodel and (ii) specifying a type of relationship between the particular node and the other node. Here, each instance of the particular node in the data model inherits the specified type of relationship from the particular node in the metamodel and thereby is permitted to form a relationship of the specified type with a respective instance of the other node in the data model.

In some examples, establishing the particular relationship is further performed by specifying a directionality of the particular relationship.

In some examples, establishing the particular relationship is further performed by specifying a forward cardinality and/or a reverse cardinality of the particular relationship.

According to some examples, creating the metamodel further includes assigning each of the first set of nodes (i) a respective label that identifies the node as a component of the metamodel and (ii) a respective name that identifies the node class represented by the respective node.

According to some examples, instantiating the new nodes of the data model includes assigning each of the new nodes (i) a respective label that matches the name of one of the first set of nodes in the metamodel and thereby identifies a node class of which the new node is an instance and (ii) a respective name that identifies the specific instance of the node class.

In some examples, the technique further includes creating a new node in the data model by (i) receiving, via the user interface, user input for selecting a particular node class from the metamodel, (ii) in response to a selection of the particular node class, displaying, by the user interface, a set of property fields for receiving user entry of properties of the new node, the set of property fields based on properties established for the selected node class in the metamodel, and (iii) accepting user input of properties into at least one of the set of property fields.

In some examples, the method further includes failing creation of the new node in response to a required property of the particular node class not being entered.

According to some examples, creating the new node in the data model is further performed by displaying a set of relationship fields for receiving user entry of relationships that the new node is permitted to have with other nodes in the data model. The set of relationship fields is based on relationships established for the selected node class in the metamodel.

The foregoing summary is presented for illustrative purposes to assist the reader in readily grasping example features presented in this disclosure. However, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments of the invention, as illustrated in the accompanying drawings, in which like reference characters refer to the same or similar parts throughout the different views.

FIG. 1 is a block diagram of an example environment in which embodiments of the improved technique can be practiced.

FIGS. 2a and 2b are diagrams that respectively show example nodes of a metamodel and example nodes of a data model, wherein nodes of the data model are created as instances of node classes defined by nodes in the metamodel.

FIG. 3 is a simulated screenshot of an example user interface, wherein the user interface displays a graph view of a particular component of the metamodel.

FIG. 4 is a simulated screenshot of the example user interface of FIG. 3, wherein the user interface displays extended fields of the particular component of the metamodel.

FIG. 5 is a simulated screenshot of the example user interface of FIGS. 3 and 4, wherein the user interface displays outbound links of the particular component of the metamodel.

FIG. 6 is a simulated screenshot of the example user interface of FIGS. 3-5, wherein the user interface displays controls and fields for adding a new link (relationship) to the particular component of the metamodel.

FIG. 7 is a simulated screenshot of the example user interface of FIGS. 3-6, wherein the user interface displays updated outbound links of the particular component of the metamodel.

FIG. 8 is a simulated screenshot of the example user interface of FIGS. 3-7, wherein the user interface displays controls and fields for adding a new node to the data model based on a node in the metamodel.

FIG. 9 is a simulated screenshot of the example user interface of FIGS. 3-8, wherein the user interface displays a graph view of the new node created in the data model.

FIG. 10 is a flowchart showing an example method of managing a graph database.

### DETAILED DESCRIPTION OF THE INVENTION

Embodiments of the invention will now be described. One should appreciate that such embodiments are provided by way of example to illustrate certain features and principles of the invention but that the invention hereof is not limited to the particular embodiments described.

An improved technique for managing a graph database provides a metamodel as a schema for a data model. The metamodel resides in the graph database and includes a set of nodes, which define respective classes of nodes that may exist in the data model. Users may operate a user interface to create new nodes in the data model as instances of the node classes defined in the metamodel.

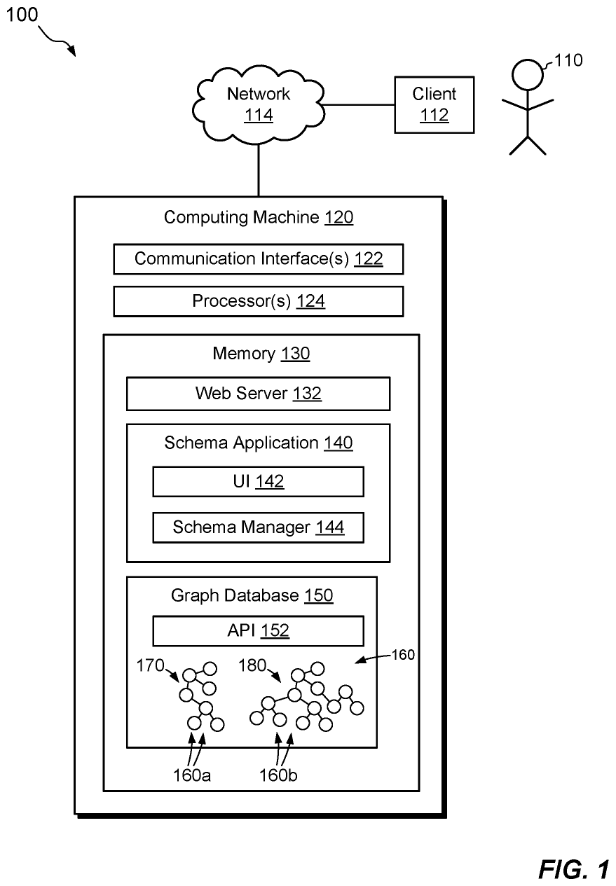

FIG. 1 shows an example environment 100 in which embodiments of the improved technique can be practiced. Here, a user 110 operates a client machine 112, which is coupled via a network 114 to a computing machine 120. Each of client machine 112 and computing machine 120 may be any computing device or system capable of connecting to the network 114 and running software, such as a laptop computer, desktop computer, server, tablet computer, smart phone, PDA (Personal Data Assistant), set-top box, gaming system, Internet of Things (IoT) device, or the like. The network 114 may be any type of network or combination of networks, such as a local area network (LAN), a wide area network (WAN), the Internet, and/or some other type of network or combination of networks.

In the example shown, the computing machine 120 includes one or more communication interfaces 122, a set of processors 124, and memory 130. The communication interfaces 122 include, for example, network interface adapters (e.g., Ethernet, Wi-Fi, or the like) for converting signals received over the network 114 to suitable form for use by the computing machine 120. The set of processors 124 includes one or more processing chips and/or assemblies, such as one or more multi-core CPUs (central processing units). The memory 130 includes both volatile memory, e.g., Random Access Memory (RAM), and non-volatile memory, such as one or more ROMs (Read-Only Memories), disk drives, solid state drives, or the like. In some examples, the computing machine 120 is coupled to external storage, such as a NAS (Network-Attached Storage) or a SAN (Storage Area Network). The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other components, which are not shown, such as an operating system, various applications, processes, and daemons. Although FIG. 1 shows computing machine 120 in a client-server arrangement, this is merely an example. For instance, an alternative arrangement may be provided in which the user 110 operates the computing machine 120 directly.

As further shown in FIG. 1, the memory 130 “includes,” i.e., realizes by execution of software instructions, a web server 132, a schema application 140, and a graph database 150. In an example, the schema application 140 is configured as a web application, such that the client 110 can access the schema application 140 via the web server 132, e.g., using a web browser or web-enabled component running on the client 110. The schema application 140 includes, for example, a user interface (UI) 142, such as a graphical user interface (GUI) or command line interface (CLI), and a schema manager 144. The schema manager 144 is configured to drive the UI 142, to respond to user input, to generate output, and to communicate with the graph database 150 via an API (Application Program Interface) 152. For example, the schema manager 144 has complete CRUD (create, read, update, delete) access to the graph database 150 and thereby can act as a front end or interface to the graph database 150. Although the graph database 150 is shown as running within the computing machine 120, it may alternatively be hosted elsewhere, such as on a separate server or in the cloud.

In a particular example, the graph database 150 is implemented using Neo4j, although other graph database technologies may be used instead. In some examples, the UI 142 and schema manager 144 are tightly integrated, and may indeed be part of a single programming environment, e.g., with forms and code served from the same program. In a particular example, which is not intended to be limiting, the schema application 140 is implemented on a GRAILS framework and uses a JavaScript API. The schema manager 144 may use a combination of server-side and client-side code. In such cases, the client-side code is executed on the client machine 112, e.g., in a web browser or client-side application running on the client machine 112.

As further shown in FIG. 1, the graph database 150 includes multiple nodes 160. As is common, the nodes 160 may be configured with relationships, properties, labels, and/or names, using the native abilities of the graph database 150. Here, we have grouped the nodes 160 into two models, a metamodel 170 and a data model 180. The metamodel 170 includes a first set of nodes 160a, and the data model 180 includes a second set of nodes 160b. Although relationships may exist among nodes 160a of the metamodel 170 and among nodes 160b of the data model 180, the two models are preferably distinct from each other, such that no node of the metamodel 170 has a direct relationship with any node of the data model 180, and vice-versa. The metamodel 170 and the data model 180 preferably reside within the same database instance, i.e., they can both be accessed at the same time from the same set of database files.

In example operation, the user 110 accesses the schema application 140 over the network 114, e.g., using a browser or client application. The schema application 140 exposes the UI 142 via the web server 132, and the user 110 operates the UI 142 from the client machine 112 to control the schema application 140. For example, the user 110 may direct the schema application 140 to create the metamodel 170, e.g., by creating nodes 160a, establishing relationships among the nodes 160a, and assigning properties labels, and/or names to the nodes 160a. As the user 110 creates and configures the nodes 160a, the schema application 140 internally identifies those nodes as components of the metamodel 170, e.g., by assigning each of the nodes 160a a specific label. For example, by giving each node 160a of the metamodel 170 the label “Component,” the schema application 140 can distinguish nodes 160a of the metamodel 170 from other nodes in the graph database 150. The specific text used in the metamodel-identifying label is not important. However, the schema application 140 should preferably apply the label consistently to nodes 160a of the metamodel 170 and should avoid using that label on nodes that are not part of the metamodel 170.

With the metamodel 170 or some portion thereof created, the user 110 may direct the schema application 140 to create new nodes 160b in the data model 180, based on the nodes 160a in the metamodel 170. For example, the schema application 140 treats the nodes 160a of the metamodel 170 as node classes, and instantiates nodes 160b of the data model 180 as specific instances of those node classes.

As instances of node classes, the nodes 160b of the data model 180 inherit characteristics from the node classes (nodes 160a) from which they are created. For example, any properties defined for nodes 160a of the metamodel 170 become properties that are allowed to be configured for instances of those nodes in the data model 180. Likewise, any relationships established among the nodes 160a in the metamodel 170 become allowable relationships that may be configured for the corresponding data-model instances. In some examples, the schema application 140 uses the properties and relationships of nodes 160a in the metamodel 170 to constrain how properties and relationships may be configured for instances in the data model 180. For example, the schema application 140 limits available properties for a node 160b in the data model 180 to only those types of properties that have been defined for the node class in the metamodel 170 from which the node in the data model 180 was instantiated. The schema application 140 also limits available relationships for a node 160b in a similar manner, such that nodes in the data model 180 can only have the types of relationships with specified types of other components as defined in the metamodel 170. As a result, the schema application 140 treats the metamodel 170 as a kind of “schema by example,” such that nodes 160b of the data model 180 are specific examples of the corresponding node classes in the metamodel 170, with the same types of properties and the same types of relationships as those defined in the metamodel 170.

Although the schema application 140 may create new nodes in the data model 180 based on classes defined in the metamodel 170, some nodes in the data model 180 may be created by other means. For example, the data model 180 may receive data feeds from various sources, where the data are already organized by some schema in the data source, such that schema application 140 can ingest the data with only minimal adjustment. Thus, it is not required that all nodes 160b of the data model 180 be created from the metamodel 170 directly.

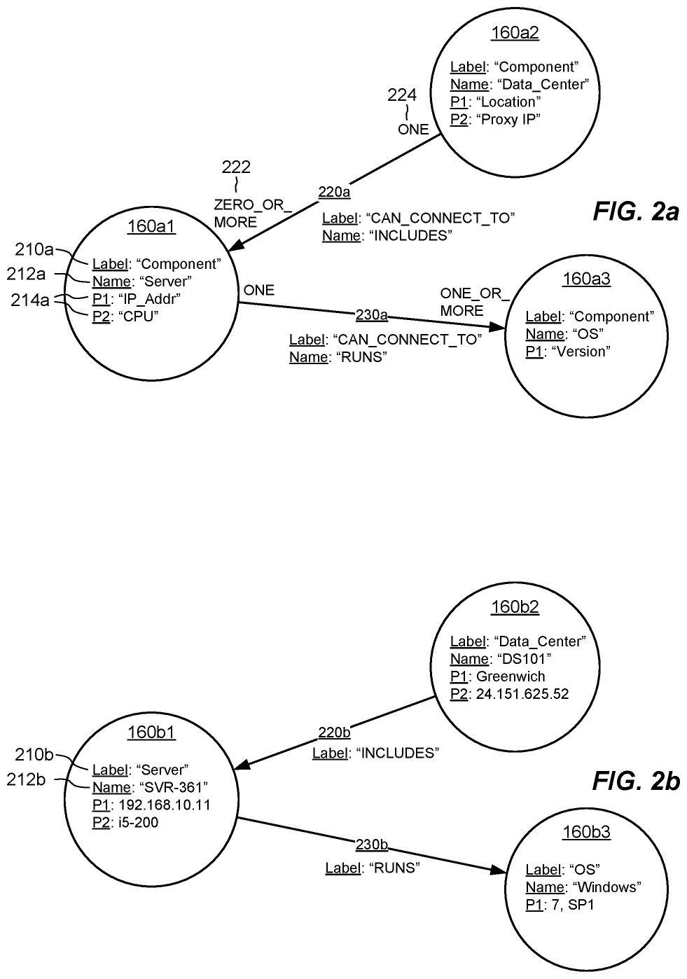

FIG. 2a shows some example nodes 160a1, 160a2, and 160a3 of the metamodel 170, and FIG. 2b shows example nodes 160b1, 160b2, and 160b3 of the data model 180, where the nodes 160b1, 160b2, and 160b3 of the data model 180 have been created as instances of the nodes 160a1, 160a2, and 160a3, respectively, of the metamodel 170. Here, we see example relationships between nodes 160a of the metamodel 170 and corresponding instances of those nodes of the data model 180. This particular example shows relationships among components of a data center, where the data center includes servers and the servers run operating systems.

As shown in FIG. 2a, node 160a1 has a label 210a called “Component,” which identifies the node 160a1 as belonging to the metamodel 170. The node 160a1 also has a name 212a called “Server,” as well as properties 214a, which include P1 (“IP Addy”) and P2 (“CPU”). Referring now to FIG. 2b, the node 160b1, which is an instance of the node class defined by node 160a1, has a label 210b called “Server.” It should be noted that this label 210b corresponds to the name 212a of the node 160a1. In an example, the schema application 140 tracks instances of each node class by ensuring that labels of nodes 160b in the data model 180 match names of nodes 160a in the metamodel 170. As other examples, the label “Data_Center” of node 160b2 matches the name of node 160a2, and the label “OS” of node 160b3 matches the name of node 160a3.

Names and properties of nodes 160b in the data model 180 are established as specific values that are particular to the respective instances. For example, node 160b1 has the name “SVR-361,” which may be used to identify a specific server instance. Likewise, property “192.168.10.11” is a specific instance of “IP_Addy” and “i5-200” is a specific instance of “CPU.” Names and properties of other nodes correspond in a similar fashion.

FIG. 2a also shows example relationships 220a and 230a. Here, relationship 220a associates the component Data_Center in the metamodel 170 with the component Server. Just as the schema application 140 used a particular label (e.g., “Component”) to identify nodes 160a in the metamodel 170, so too does the schema application 140 use a particular label (e.g., “CAN_CONNECT_TO”) to identify relationships in the metamodel 170. Thus, for example, the schema application 140 treats any relationship having the label CAN_CONNECT_TO as a metamodel relationship. The name of the relationship is generally descriptive. For example, the name “INCLUDES” describes the relationship between a data center and a server. In a similar manner to that described above for nodes, the schema application 140 associates classes of relationships defined in the metamodel 170 with instances of those relationships in the data model 180 by ensuring that labels of relationships in the data model 180 match names of relationships in the metamodel 170. Thus, relationship instances 220b and 230b in FIG. 2b have labels “INCLUDES” and “RUNS,” respectively, which match the corresponding labels in the metamodel 170.

Each relationship has a direction, which may be inbound or outbound, as indicated by the arrows. Each relationship may also have a forward cardinality 222 and/or a reverse cardinality 224. Each cardinality 222 or 224 indicates a number of elements of that type that can be linked to. For example, relationship 220a shows that a data center may link to “ZERO_OR_MORE” servers, but a server may link to only “ONE” data center. Other possible values for cardinality include “ZERO” and “ONE_OR_MORE,” for example.

The schema application 140 preferably provides the UI 142 in the form of a GUI, which promotes user-friendly access to the functionality of the schema application 140 for managing metamodels and data models without requiring expert-level knowledge. Although this disclosure focuses on certain features related to metamodels and data models, one should appreciate that the schema application 140 may be extended to provide a comprehensive front-end to the graph database 150, e.g., to promote ease of use by ordinary users.

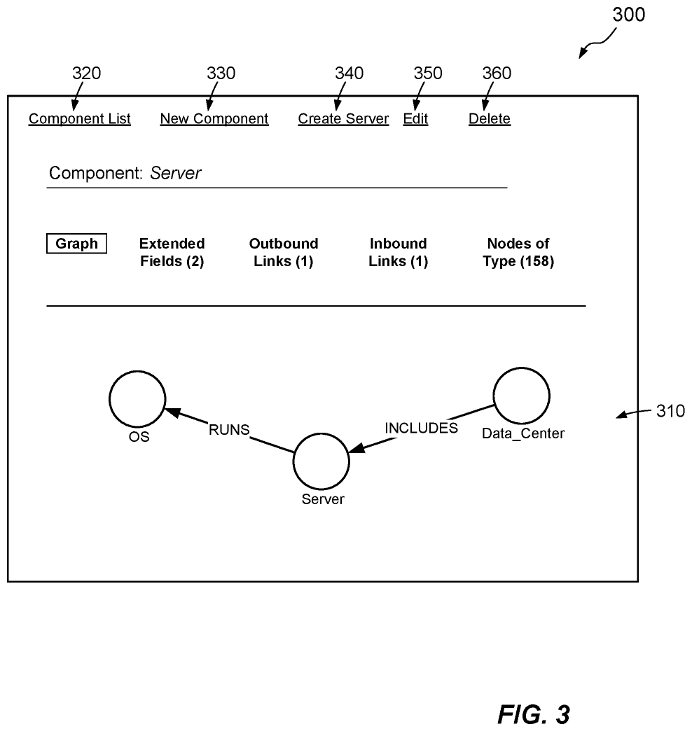

FIGS. 3-9 show example simulated screenshots produced by the schema application 140 and rendered by the UI 142. The simulated screenshots are intended to show user-friendly examples but are not intended to be limiting. Those skilled in the art will recognize that similar functionality may be achieved using a range of interface solutions.

FIG. 3 shows a simulated screenshot 300 generated by the schema application 140, which displays a metamodel fragment of the component “Server” (also seen as node 160a1 in FIG. 2a). A graph view 310 is shown, with the selected component in the center and its immediate relationships depicted around it. One can easily see that the node class “Server” has an outbound “RUN” relationship with metamodel component “OS” (node 160a2) and has an inbound “INCLUDES” relationship with a metamodel component “Data Center” (node 160a3).

Users may select other views, as shown above the graph, such as “Extended Fields,” “Outbound Links” (relationships), and “Inbound Links,” with the numbers in parentheses specifying the number of extended fields (2), outbound links (1), and inbound links (1) that have been configured for the selected component (Server). Users may also view “Nodes of Type,” which provides a display of all nodes in the data model 180 that are instances of the Server node class. In the depicted example, there is a total of 158 Servers in the data model 180.

Links at the top of the screen provide additional options. These include a “Component List” link 320, for displaying a list of all components in the metamodel 170, a “New Component” link 330, for creating a new component in the metamodel 170, and a “Create Server” link 340, for creating a new instance in the data model 180 of the Server class. They also include an “Edit” link 350 for editing the current component and a “Delete” link 360 for deleting it.

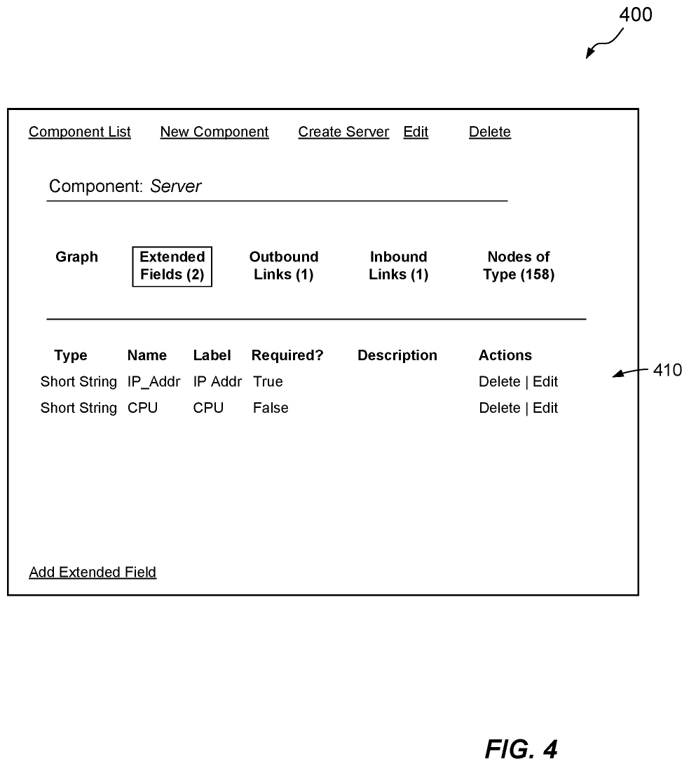

FIG. 4 shows a simulated screenshot 400 generated by the schema application 140, e.g., in response to the user 110 selecting “Extended Fields” on the screen displayed in FIG. 3. Here, the screen displayed in screenshot 400 shows extended fields of the Server component represented by node 160a1 (FIG. 2a). The display has replaced the graph view 310 with a list view 410 of extended fields. These include the properties “IP Addr” and “CPU” from FIG. 2a. Users can specify whether each property is “Required” (True or False), where a required property is one that must be provided for all instances of the current class (Server). Here, users must specify an “IP_Addy” for any instance of the Server class, but specifying a “CPU” is optional. Users may operate this screen to “Add Extended Field,” which has the effect of creating a new property type for the current class.

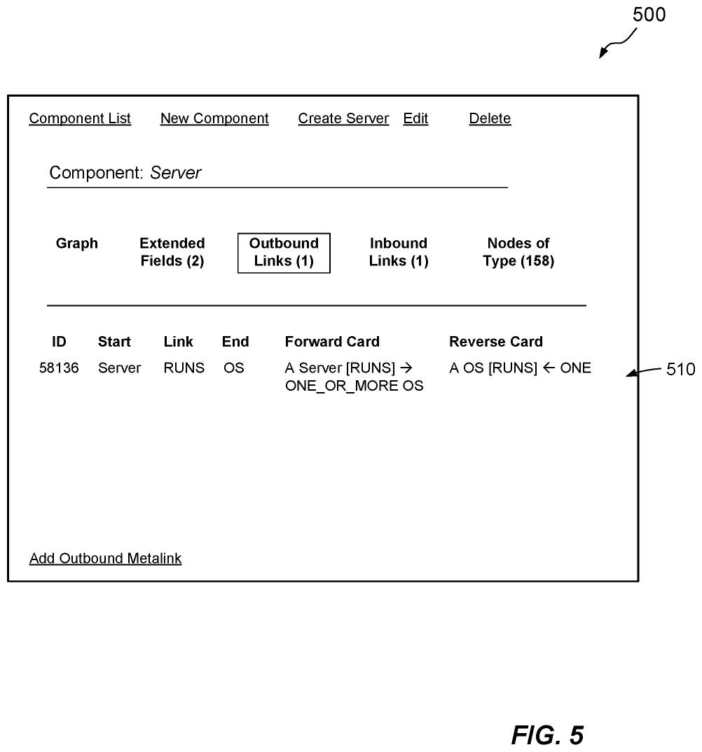

FIG. 5 shows a simulated screenshot 500 generated by the schema application 140, e.g., in response to the user 110 selecting “Outbound Links” on the screens displayed in FIGS. 3 and 4. The screenshot 500 shows a list view 510 of all outbound links of the Server component represented by node 160a1 (FIG. 2a). A total of one outbound link currently exists (see link 230a in FIG. 2a). In the example shown, the list view 510 displays, for each outbound link, an identifier (e.g., a unique number), a start node (Server), a link (RUNS), and end node (OS), and both forward and reverse cardinality (222 and 224 of FIG. 2a). Users may operate “Add Outbound Metalink,” which has the effect of creating a new outbound link for the current class. Links created in the metamodel 170 may be referred to herein as “metalinks.”

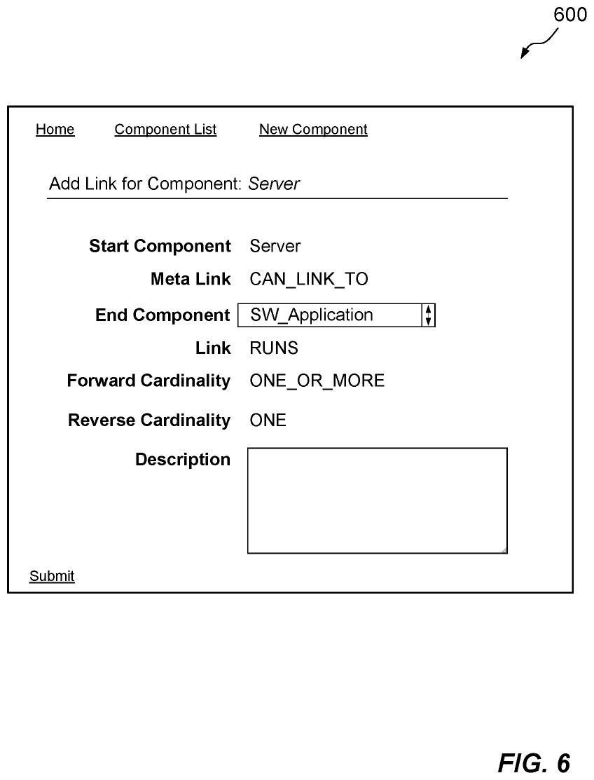

FIG. 6 shows a simulated screenshot 600 generated by the schema application 140, e.g., in response to the user 110 operating the control (“Add Outbound Metalink”) in FIG. 5. Here, users can define a new outbound link for the Server class, by filling in the fields displayed. In this example, the user 110 has created a new outbound link called “RUNS” to a component called “SW_Application,” with the indicated forward and reverse cardinality.

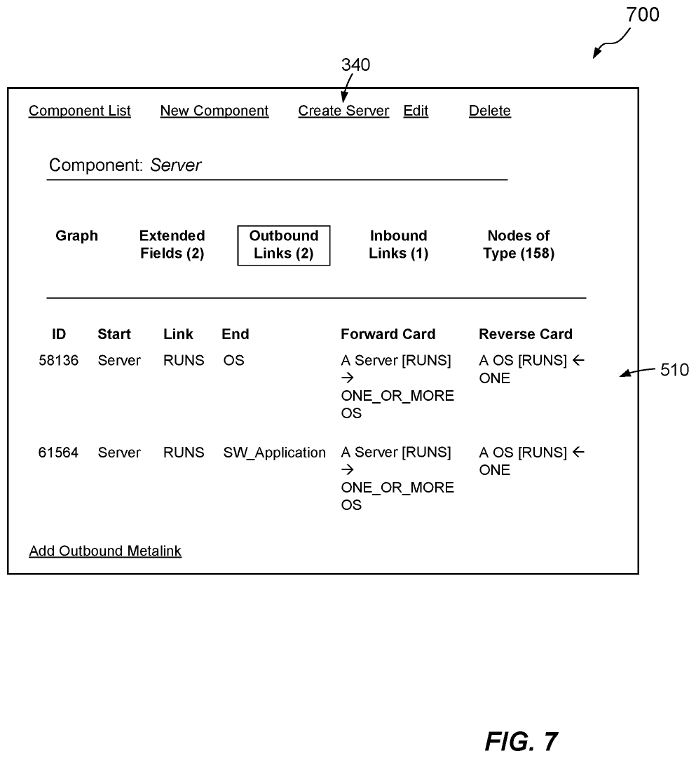

FIG. 7 shows an example result of creating this new outbound link. Here, simulated screenshot 700 is similar to the screenshot 500, but this time two outbound links are listed, including the link to “SW_Application” just created.

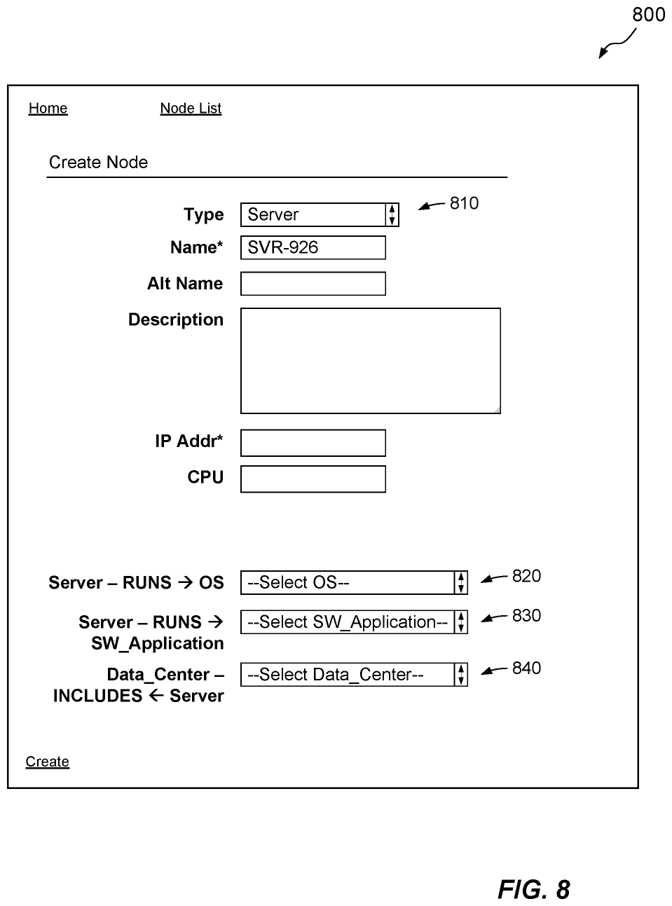

FIG. 8 shows a simulated screenshot 800 generated by the schema application 140, e.g., in response to the user 110 clicking the “Create Server” link 340 of FIG. 7. Using the screen 800, the user 110 can instantiate the Server class (node 160a1) to create and configure a specific Server instance in the data model 180. For example, the user 110 enters a name “SVR-926” and may enter additional properties, some of which may be required, as indicated by asterisks.

In an example, the property fields displayed on screen 800 are limited to those extended fields that are defined in the metamodel 170 for the Server component (node 160a1). Accordingly, the schema application 140 displays different property fields for different metamodel components. Users can change the component “Type” by clicking the field 810. In an example, when the user 110 clicks the field 810 to select a different component type, the schema application 140 performs a live lookup into the graph database 150, e.g., via a Cypher query, to identify all components of the metamodel 170, e.g., all nodes 160a that have the “Component” label. The schema application 140 then displays a drop-down list of the returned components and allows the user 110 to select one. When the new component type is selected, the displayed property fields change to reflect those that have been defined for the new component type.

As part of creating the new Server instance in FIG. 8, the screen 800 also displays a field for each of the links defined for the Server class. For example, the screen 800 displays a field for each of the outbound links, which here include “Server—RUNS →OS” and “Server—RUNS→SW_Application.” In some examples, the screen 800 also displays a field for each of the inbound links, which here includes “Data Center INCLUDES←Server.” When the user 110 selects any of these link fields, the schema application 140 queries the data model 180 in the graph database 150 to identify all instances of the component type defined as the end node for the respective link. For example, clicking the field 820 prompts a lookup of all “OS” instances in the data model 180, i.e., all nodes 160b having the “OS” label, and displays the query results in a select list. The user then selects one or more items from the select list. In some examples, the number of different items that the user 110 can select is based on the cardinality of the relationship. For example, if the forward cardinality of the relationship represented by field 820 is “ONE,” then the user 110 may be limited to selecting only a single item. But if the forward cardinality is “ONE_OR_MORE,” the user 110 may be able to select multiple items. Similar principles apply for fields 830 and 840. When the user 110 finishes configuring the new instance, the user 110 can click “Create” to instantiate the new instance in the data model 180.

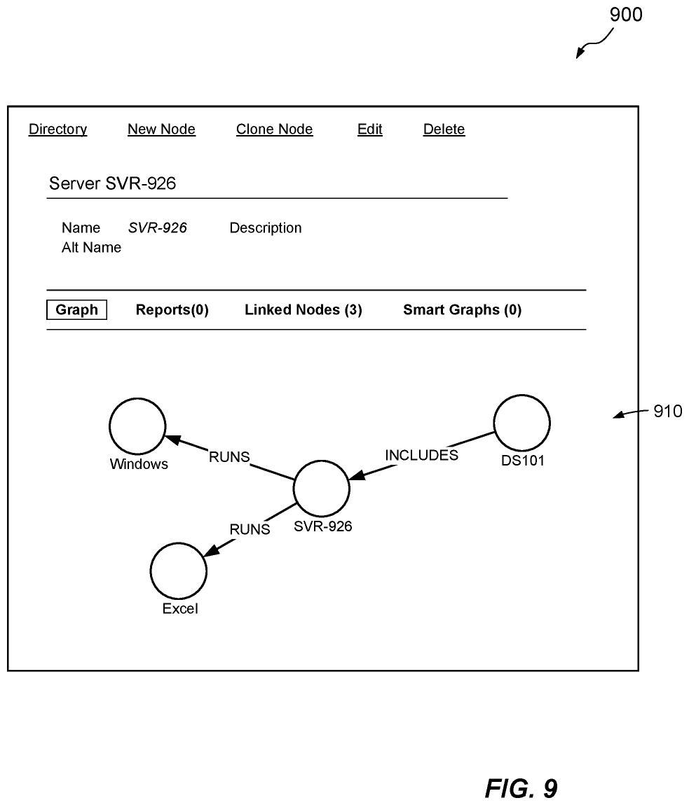

FIG. 9 shows example results of this “Create” operation. Here, simulated screenshot 900 shows the newly-created server instance, SVR-926. The pictured graph view 910 is similar to the graph view 310 shown in FIG. 3 for the Server component of the metamodel 170, but here the graph view 910 pertains to the particular instance in the data model 180 and reflects the newly-created outbound link for “SW_Application” (FIG. 6).

In some examples, the schema application 140 supports numerous related features for operating the data model 180, e.g., to avoid the need for non-expert users to access the graph database 150 directly. For example, the schema application 140 may support common reports. It may also support smart graphs, which allow users to view report results in graphical form. The schema application 140 may store pre-designed queries (e.g., Cypher queries) within nodes of the graph database 150, e.g., as text-area properties. It may also support parameterized queries, e.g., by presenting data entry fields for accepting any needed parameters. In some examples, the schema application 140 includes a query builder, which reads the metamodel 170 and guides users to design queries that conform to the structure of the metamodel 170.

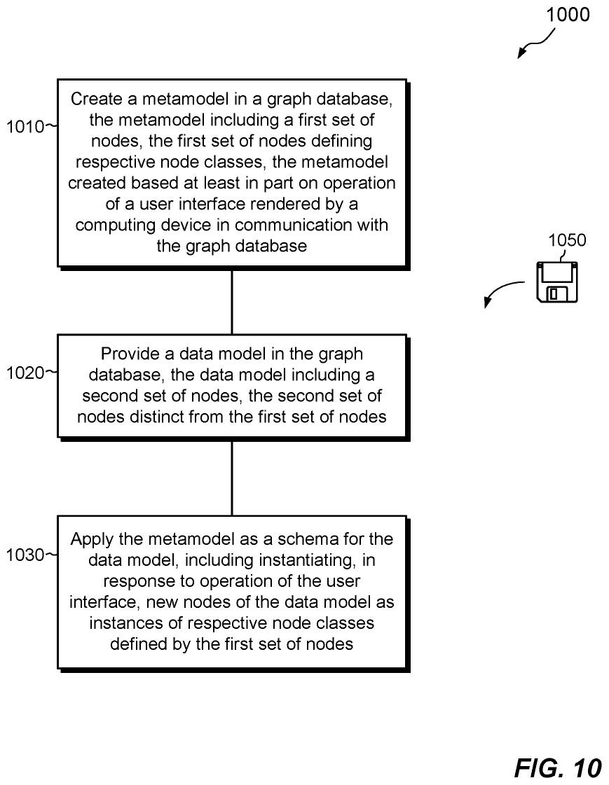

FIG. 10 shows an example method 1000 that summarizes certain features described above. The method 1000 may be carried out in connection with the environment 100, for example, by the software constructs described in connection with FIG. 1, which reside in the memory 130 of the computing machine 120 and are run by the set of processors 124. The various acts of method 1000 may be ordered in any suitable way. Accordingly, embodiments may be constructed in which acts are performed in orders different from that illustrated, which may include performing some acts simultaneously.

At 1010, a metamodel 170 is created in the graph database 150. The metamodel 170 includes a first set of nodes 160a, which define respective node classes. The metamodel 170 is created based at least in part on operation of a user interface 142 served by a computing machine 120 in communication with the graph database 150, which may run within the computing machine 120 or remotely (e.g., on a separate server).

At 1020, a data model 180 is provided in the graph database 150. As shown for example in FIG. 1, the data model 180 includes a second set of nodes 160b, which is distinct from the first set of nodes 160a.

At 1030, the metamodel 170 is applied as a schema for the data model 180, e.g., by instantiating, in response to operation of the user interface 142, new nodes 160b of the data model 180 as instances of respective node classes defined by the first set of nodes 160a.

An improved technique has been described which provides a schema for a data model 180 in a graph database 150 by creating a metamodel 170. The metamodel 170 resides in the graph database 150 and includes a set of nodes 160a, which define respective classes of nodes that may exist in the data model 180. Users may operate a user interface 142 to create new nodes 160b in the data model 180 as instances of the node classes defined in the metamodel 170. The new nodes 160b may inherit characteristics of the node classes, which limit the scope of permitted properties and/or relationships of the new nodes in the data model 180 to those established for the respective node classes in the metamodel 170. In this manner, the node classes defined in the metamodel 180 enforce structure on the instances of those node classes created in the data model 180, thereby enabling the metamodel 170 to function as a schema for the data model 180.

Having described certain embodiments, numerous alternative embodiments or variations can be made. For example, although names and labels have been used herein to associate node classes with instances of those node classes, this is merely an example. Alternatively, properties or other constructs may be used to establish these associations. Also, although particular features of a GUI have been shown for enabling users to control the schema application 140, the particular features as shown are intended as illustrative examples rather than as limiting.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 1050 in FIG. 10). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Further, although ordinal expressions, such as “first,” “second,” “third,” and so on, may be used as adjectives herein, such ordinal expressions are used for identification purposes and, unless specifically indicated, are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Although certain embodiments are disclosed herein, it is understood that these are provided by way of example only and that the invention is not limited to these particular embodiments.

Those skilled in the art will therefore understand that various changes in form and detail may be made to the embodiments disclosed herein without departing from the scope of the invention.

What is claimed is:

1. A method of managing a graph database, the method comprising:
creating a metamodel in the graph database, the metamodel including a first set of nodes, the first set of nodes defining respective node classes, the metamodel created based at least in part on operation of a user interface served by a computing machine in communication with the graph database;
providing a data model in the graph database, the data model including a second set of nodes, the second set of nodes distinct from the first set of nodes; and
applying the metamodel as a schema for the data model, including instantiating, in response to operation of the user interface, new nodes of the data model as instances of respective node classes defined by the first set of nodes.

2. The method of claim 1, further comprising operating both the metamodel and the data model within a single instance of the graph database.

3. The method of claim 1, wherein creating the metamodel includes establishing a set of properties of a particular node of the first set of nodes, the set of properties defining respective types of characteristics that the user interface permits users to assign to instances of the particular node created in the data model.

4. The method of claim 3 wherein establishing the set of properties of the particular node includes presenting, by the user interface, a control for specifying whether a property is required to be assigned by instances of the particular node created in the data model.

5. The method of claim 3, wherein creating the metamodel includes establishing a set of relationships for the particular node in the metamodel, the set of relationships defining respective types of connections that are permitted by instances of the particular node with other nodes in the data model.

6. The method of claim 5, wherein establishing the set of relationships for the particular node in the metamodel includes establishing a particular relationship by:
identifying another node in the metamodel; and
specifying a type of relationship between the particular node and the other node,
wherein each instance of the particular node in the data model inherits the specified type of relationship from the particular node in the metamodel and thereby is permitted to form a relationship of the specified type with a respective instance of the other node in the data model.

7. The method of claim 6, wherein establishing the particular relationship is further performed by specifying a directionality of the particular relationship.

8. The method of claim 7, wherein establishing the particular relationship is further performed by specifying a forward cardinality and/or a reverse cardinality of the particular relationship.

9. The method of claim 5, wherein creating the metamodel further includes assigning each of the first set of nodes (i) a respective label that identifies the node as a component of the metamodel and (ii) a respective name that identifies the node class represented by the respective node.

10. The method of claim 9, wherein instantiating the new nodes of the data model includes assigning each of the new nodes (i) a respective label that matches the name of one of the first set of nodes in the metamodel and thereby identifies a node class of which the new node is an instance and (ii) a respective name that identifies the specific instance of the node class.

11. The method of claim 5, wherein the metamodel includes a plurality of relationships defined among the first set of nodes, and wherein each of the plurality of relationships has a respective label that identifies the relationship as belonging to the metamodel.

12. The method of claim 5, further comprising creating a new node in the data model by:
receiving, via the user interface, user input for selecting a particular node class from the metamodel;
in response to a selection of the particular node class, displaying, by the user interface, a set of property fields for receiving user entry of properties of the new node, the set of property fields based on properties established for the selected node class in the metamodel; and
accepting user input of properties into at least one of the set of property fields.

13. The method of claim 12, wherein the method further comprises failing creation of the new node in response to a required property of the particular node class not being entered.

14. The method of claim 12, wherein creating the new node in the data model is further performed by displaying a set of relationship fields for receiving user entry of relationships that the new node is permitted to have with other nodes in the data model, the set of relationship fields based on relationships established for the selected node class in the metamodel.

15. A computerized apparatus, comprising control circuitry that includes a set of processors coupled to memory, the control circuitry constructed and arranged to:
create a metamodel in a graph database, the metamodel including a first set of nodes, the first set of nodes defining respective node classes, the metamodel created based at least in part on operation of a user interface served by a computing machine in communication with the graph database;
provide a data model in the graph database, the data model including a second set of nodes, the second set of nodes distinct from the first set of nodes; and
apply the metamodel as a schema for the data model, including instantiating, in response to operation of the user interface, new nodes of the data model as instances of respective node classes defined by the first set of nodes.

16. A computer program product including a set of non-transitory, computer-readable media having instructions which, when executed by control circuitry of a computerized apparatus, cause the control circuitry to perform a method of managing a graph database, the method comprising:
creating a metamodel in the graph database, the metamodel including a first set of nodes, the first set of nodes defining respective node classes, the metamodel created based at least in part on operation of a user interface served by a computing machine in communication with the graph database;
providing a data model in the graph database, the data model including a second set of nodes, the second set of nodes distinct from the first set of nodes; and
applying the metamodel as a schema for the data model, including instantiating, in response to operation of the user interface, new nodes of the data model as instances of respective node classes defined by the first set of nodes.

17. The computer program product of claim 16, wherein creating the metamodel includes establishing a set of properties of a particular node of the first set of nodes, the set of properties defining respective types of characteristics that the user interface permits users to assign to instances of the particular node created in the data model.

18. The computer program product of claim 17, wherein creating the metamodel includes establishing a set of relationships for the particular node in the metamodel, the set of relationships defining respective types of connections that are permitted by instances of the particular node with other nodes in the data model.

19. The computer program product of claim 18, wherein establishing the set of relationships for the particular node in the metamodel includes establishing a particular relationship by:
identifying another node in the metamodel; and
specifying a type of relationship between the particular node and the other node,
wherein each instance of the particular node in the data model inherits the specified type of relationship from the particular node in the metamodel and thereby is permitted to form a relationship of the specified type with a respective instance of the other node in the data model.

20. The computer program product of claim 18,
wherein creating the metamodel further includes assigning each of the first set of nodes (i) a respective label that identifies the node as a component of the metamodel and (ii) a respective name that identifies the node class represented by the respective node, and
wherein instantiating the new nodes of the data model includes assigning each of the new nodes (i) a respective label that matches the name of one of the first set of nodes in the metamodel and thereby identifies a node class of which the new node is an instance and (ii) a respective name that identifies the specific instance of the node class.
